(19) United States
(12) Patent Application Publication
(10) Pub. No.: US 2021/0325176 A1
(43) Pub. Date: Oct. 21, 2021

(54) INFORMATION PROCESSING DEVICE, TERMINAL DEVICE, INFORMATION PROCESSING METHOD AND INFORMATION PROCESSING PROGRAM

(71) Applicant: Sony Corporation, Tokyo (JP)

(72) Inventor: Shoichi Awai, Tokyo (JP)

(21) Appl. No.: 17/268,752

(22) PCT Filed: Aug. 6, 2019
(86) PCT No.: PCT/JP2019/030801

§ 371 Date: Feb. 16, 2021

(30) Foreign Application Priority Data
Sep. 13, 2018 (JP) 2018-171682

(51) Int. Cl. G01B 11/30; G06T 7/55; G06T 7/521; H04N 5/247; H04N 5/225; B60Q 1/14

(52) U.S. Cl. CPC G01B 11/303; G06T 7/55; G06T 7/521; H04N 5/247; B60Q 2300/32; B60Q 1/1415; G06T 2207/10152; G06T 2207/30252; H04N 5/2256

(57) ABSTRACT

An information processing device (10) according to an embodiment includes: a control unit (40) and a processing unit (30). The control unit controls driving of a light source (21) that can irradiate light to a subject surface in accordance with control information. An image adaptive to light irradiated on the subject surface from the light source is detected by an image sensor (20). The processing unit performs processing for acquiring state information indicating a state of the subject surface based on the image adaptive to light irradiated on the subject surface from the light source detected by the image sensor and the control information.

### FIELD

The present disclosure relates to an information processing device, a terminal device, an information processing method and an information processing program.

### BACKGROUND

By detecting a state of a road surface in front of a vehicle, safe travel of the vehicle, improvement in ride quality, and the like can be expected. As a method for detecting such a road surface state in front of the vehicle, a method using an image sensor and a method using a sensor enabling the distance to an object to be measured are known. In a case in which the road surface state is detected based on the distance measurement result, it is common to use a sensor that utilizes reflection of a laser beam as the distance measurement sensor.

### CITATION LIST

### Patent Literature

Patent Literature 1: JP 06-300537 A

Patent Literature 2: JP 2017-19713 A

### SUMMARY

### Technical Problem

Among these, the distance measurement based on reflection of a laser beam is a method that uses the traveling speed of light, and since the speed of light is high, high accuracy is required for the device, which increases the cost. Therefore, it is required to detect the road surface state with use of an image sensor. However, the method using an image sensor has a problem in which the measurement accuracy is influenced by the surface shape, brightness, saturation, and the like of a subject.

The present disclosure proposes an information processing device, a terminal device, an information processing method and an information processing program enabling a state of a subject surface to be detected with higher accuracy with use of an image sensor.

### Solution to Problem

For solving the problem described above, an information processing device according to one aspect of the present disclosure has a control unit that controls driving of a light source in accordance with control information; and a processing unit that acquires state information indicating a state of a subject surface based on an image adaptive to light irradiated on the subject surface from the light source detected by an image sensor and the control information.

### Advantageous Effects of Invention

According to the present disclosure, a state of a subject surface can be detected with higher accuracy with use of an image sensor. Note that the effects described here are not necessarily limited, and any of the effects described in the present disclosure may be provided.

### BRIEF DESCRIPTION OF DRAWINGS

FIG. 1 is a block diagram schematically illustrating an example of a configuration of an information processing device applicable to each of the embodiments of the present disclosure.

FIG. 2 is a block diagram illustrating an example of a hardware configuration of the information processing device applicable to each of the embodiments of the present disclosure.

FIG. 3 is a block diagram illustrating an example of a configuration of an information processing device according to a first embodiment.

FIG. 4 is a diagram for illustrating synchronous detection applicable to the first embodiment.

FIG. 5 is a flowchart illustrating an example of processing in the information processing device according to the first embodiment.

FIG. 6 is a diagram illustrating an example of a change of a frequency f of a reference signal applicable to the first embodiment.

FIG. 7 is a diagram for schematically illustrating detection of a total internal reflection region according to a second embodiment.

FIG. 8 is a diagram for schematically illustrating detection of the total internal reflection region according to the second embodiment.

FIG. 9 is a block diagram illustrating an example of a configuration of an information processing device according to the second embodiment.

FIG. 10 is a diagram illustrating an example of arrangement of a light source and an image sensor according to the second embodiment.

FIG. 11 is a flowchart of an example illustrating processing according to the second embodiment.

FIG. 12 is a diagram illustrating an example of a captured image of a state in which a small object is on a white flat surface.

FIG. 13 is a diagram for describing an example of a pattern image.

FIG. 14 is a diagram illustrating an example of an image captured in an oblique direction from the near side by projecting the pattern image from substantially directly above the flat surface including the small object.

FIG. 15 is an enlarged view of the example of the image captured in an oblique direction from the near side by projecting the pattern image from substantially directly above the flat surface including the small object.

FIG. 16 is a diagram illustrating an example of arrangement of the light source and the image sensor according to a third embodiment.

FIG. 17 is a block diagram illustrating an example of a configuration of an information processing device according to the third embodiment.

FIG. 18 is a flowchart of an example illustrating processing according to the third embodiment.

FIG. 19 is a diagram illustrating an example in which three image sensors are applied to one light source.

FIG. 20 is a diagram for more specifically describing an application example of the third embodiment.

FIG. 21 is a diagram for describing an example of a pattern image.

FIG. 22A is a diagram for more specifically describing processing according to a fourth embodiment.

FIG. 22B is a diagram for more specifically describing the processing according to the fourth embodiment.

FIG. 23 is a block diagram illustrating a schematic functional configuration example of a system for controlling a vehicle applicable to a fifth embodiment.

FIG. 24 is a diagram illustrating an example of installation positions of an image capturing device included in a data acquisition unit.

### DESCRIPTION OF EMBODIMENTS

Hereinbelow, embodiments of the present disclosure will be described in detail with reference to the drawings. Note that, in each of the following embodiments, identical components are labeled with the same reference signs, and duplicate description is omitted.

[Overview of Present Disclosure]

In an information processing device according to the present disclosure, light including reflected light into which light emitted from a light source is reflected on a subject surface is detected in an image sensor, and state information indicating a state of the subject surface is acquired based on an image output as a detection result from the image sensor. At this time, the light source is driven based on predetermined control information, and the state information is acquired based on the control information and the image output from the image sensor. Therefore, the state information can be acquired adaptively to the light emitted from the light source, and the state of the subject surface can be acquired with higher accuracy.

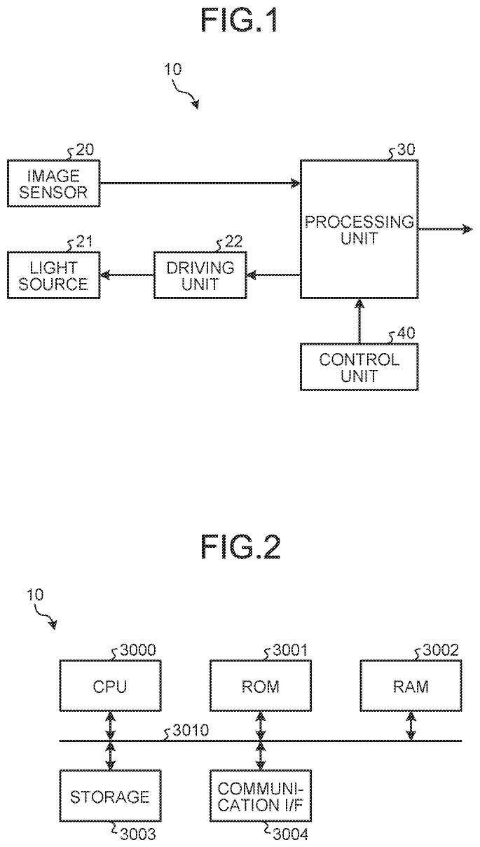

FIG. 1 is a block diagram schematically illustrating an example of a configuration of an information processing device applicable to each of the embodiments of the present disclosure. In FIG. 1, an information processing device 10 includes a processing unit 30 and a control unit 40. The processing unit 30 performs predetermined processing on an image input from an image sensor 20 in accordance with control by means of the control unit 40. The processing unit 30 also controls light emission by means of a light source 21 via a driving unit 22 in accordance with control by means of the control unit 40.

The image sensor 20 is a camera, for example, and converts received light into an image signal serving as an electric signal with use of an imaging element such as a charge coupled device (CCD) image sensor and a complementary metal oxide semiconductor (CMOS) image sensor. For example, the image sensor 20 performs exposure at a predetermined frame rate (30 frames per second (fps), 60 fps, or the like) and outputs an image signal. The image sensor 20 performs predetermined signal processing such as denoising and auto gain control (AGC) processing on the image signal. The image sensor 20 further converts the analog image signal subjected to the signal processing into digital image data and outputs the digital image data. This image data is input into the processing unit 30.

The light source 21 includes a light emitting element and an optical system for collecting light emitted by the light emitting element and emitting the light in a predetermined direction, and the light emitting element is driven by the driving unit 22 to emit light. As the light emitting element, a light emitting diode (LED) is used, for example. The light source 21 emits white light. The light source 21 is not limited to this and may be one that emits infrared light.

Note that, in the example in FIG. 1, although the driving unit 22 drives the light source 21 in accordance with control by means of the processing unit 30, instead of this example, a configuration can be employed in which the driving unit 22 is controlled by the control unit 40 so that the driving unit 22 may drive the light source 21.

For example, the information processing device 10 is mounted on a movable body such as a vehicle, and the light source 21 emits white light. A headlight for illuminating a front side of the vehicle and a road surface in front of the vehicle can be applied to the light source 21. An in-vehicle camera mounted on the vehicle can be applied to the image sensor 20. Hereinbelow, it is assumed that the image sensor 20 is installed on the vehicle so that an image of at least the road surface in front of the vehicle can be captured. By installing the image sensor 20 in this manner, a state of the road surface in front of the traveling vehicle on which the image sensor 20 is mounted (in a case of moving forward) can be figured out based on the image data acquired by the image sensor 20.

FIG. 2 is a block diagram illustrating an example of a hardware configuration of the information processing device 10 applicable to each of the embodiments of the present disclosure. In FIG. 2, the information processing device 10 includes a central processing unit (CPU) 3000, a read only memory (ROM) 3001, a random access memory (RAM) 3002, a storage 3003, and a communication interface (I/F) 3004, each of which is connected to a bus 3010. In this manner, the information processing device 10 includes the CPU 3000 and the memories (ROM 3001, RAM 3002, and the like) and has a configuration corresponding to a computer.

A non-volatile memory such as a flash memory and a hard disk drive can be applied to the storage 3003. The CPU 3000 controls an entire operation of the information processing device 10 with use of the RAM 3002 as a work memory in accordance with a program prestored in the ROM 3001 and the storage 3003.

The communication I/F 3004 controls communication between the information processing device 10 and an external device.

The functions of the processing unit 30 and the control unit 40 illustrated in FIG. 1 are fulfilled by an information processing program according to the present disclosure, which operates on the CPU 3000. Instead of this, the processing unit 30, the control unit 40, and each unit included in the processing unit 30 described below may be configured by a hardware circuit in which the respective units operate in cooperation with each other.

The information processing program for fulfilling each function related to the information processing device 10 of the present disclosure is recorded as a file in an installable format or in an executable format in a computer-readable recording medium such as a compact disk (CD), a flexible disk (FD), and a digital versatile disk (DVD) and is provided. Instead of this, the information processing program may be provided by storing the program on a computer connected to a network such as the Internet and letting the program downloaded via the network. Also, the information processing program may be configured to be provided or distributed via a network such as the Internet.

The information processing program has a modular configuration including the processing unit 30 and the control unit 40. As actual hardware, the CPU 3000 reads the information processing program from a storage medium such as the ROM 3001 and the storage 3003 and executes the program to cause the aforementioned respective units to be loaded onto a main storage device such as the RAM 3002, and the processing unit 30 and the control unit 40 are generated on the main storage device.

### First Embodiment

Next, a first embodiment will be described. In the first embodiment, the light source 21 is driven by a sine wave or a pseudo sine wave having a frequency f, and the image data captured by the image sensor 20 is subjected to synchronous detection in accordance with the frequency f. The captured image data is subjected to the synchronous detection to enable high S/N detected image data to be obtained.

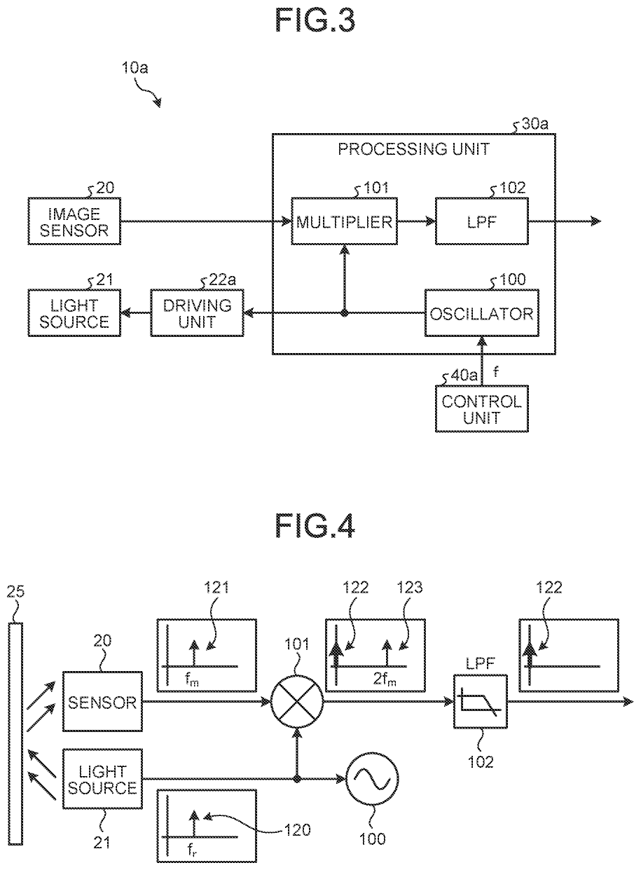

FIG. 3 is a block diagram illustrating an example of a configuration of an information processing device 10a according to the first embodiment. In FIG. 3, a processing unit 30a of the information processing device 10a includes an oscillator 100, a multiplier 101, and a low-pass filter (LPF) 102. The oscillator 100 generates a sine wave having the frequency f appeared in control information supplied from a control unit 40a or a pseudo sine wave for pulse width modulation (PWM) driving. Hereinbelow, for illustrative purposes, description will be provided assuming that the oscillator 100 generates a sine wave.

The sine wave having the frequency f generated in the oscillator 100 is supplied to the multiplier 101 and a driving unit 22a. The driving unit 22a drives the light source 21 in accordance with the sine wave having the frequency f. For this reason, light emitted from the light source 21 blinks with a cycle of 1/f [sec] in accordance with the sine wave.

The multiplier 101 performs processing for multiplying the image data output from the image sensor 20 by the sine wave having the frequency f. Although the details will be described below, synchronous detection based on a reference signal is executed for the image data output from the image sensor 20 by the multiplier 101. The synchronously detected image data output from the multiplier 101 is supplied to the LPF 102. The LPF 102 lets the image data with a frequency component equal to or lower than the frequency f, for example, pass therethrough to obtain image data after synchronous detection (referred to as detected image data). The detected image data is output from the information processing device 10.

FIG. 4 is a diagram for illustrating synchronous detection applicable to the first embodiment. As illustrated in FIG. 4, light emitted from the light source 21 is modulated by a reference signal 120, which is the sine wave having the frequency f generated by the oscillator 100, and the modulated light illuminates a road surface 25. Reflected light into which the light emitted from the light source 21 is reflected on the road surface 25 is detected at the image sensor 20. The intensity of this reflected light is directly proportional to the reflectance of the light from the light source 21 on the road surface 25.

The reference signal and a measured signal, that is, an output 121 of the image sensor 20, are sine waves having the same phase as that of the frequency f of the reference signal and having a different amplitude. The reference signal that drives the light source 21 has a constant amplitude. On the other hand, the amplitude of the measured signal changes in accordance with the intensity of the reflected light. The multiplier 101 multiplies the two sine waves, the reference signal and the measured signal, as illustrated in Equation (1).

A sin(2πfₘt)×B sin(2πfₘt)=1/2AB−1/2AB cos(4πfₘt) (1)

Note that, in Equation (1), a term related to a constant A indicates the reference signal 120, for example, and a term related to a constant B indicates the measured signal (output 121), for example. Also, in Equation (1), the frequency f is represented as “fₘ”. A value t is a variable related to time.

As illustrated on the right side of Equation (1), the multiplication result includes a term that includes no trigonometric function and a term that includes a trigonometric function (cos ( )). That is, the term that includes no trigonometric function is a DC component 122, and the term that includes the trigonometric function is a frequency component 123 having a frequency twice the original frequency f. Subsequently, the LPF 102 lets a component having the frequency f or lower, for example, pass therethrough. This readily enables only the DC component 122 to be extracted with high accuracy. The DC component 122 is the detected image data into which the image data captured by the image sensor 20 is synchronously detected.

The DC component 122 represents the intensity of the reflected light of the light from the light source 21 having the frequency f and has almost no other disturbance components. Therefore, the detected image data output from the LPF 102 is high S/N data.

Meanwhile, the accuracy of image recognition based on the image data captured by the image sensor 20 is influenced by the surface shape, brightness, and saturation of a subject. For example, in a situation in which snow accumulates, the entire surface becomes white, which may make object recognition extremely difficult. Also, in a situation in which the vehicle as a movable body is traveling, there is a case in which a change having a wide dynamic range exists in one image, such as a situation under the scorching sun in midsummer and the shadow in the situation, a sharp change in brightness when entering or exiting a tunnel, and nighttime in a suburb. Therefore, even in a case in which measures such as the increase in dynamic range are taken in the image sensor 20, there is naturally a limit to the performance improvement by the image sensor 20 alone.

Conversely, by applying the synchronous detection according to the first embodiment to the output of the image sensor 20, it is possible to obtain high S/N detected image data and improve the accuracy of image recognition. For example, by applying the synchronous detection to the output of the image sensor 20, the influences of a shadow part of light on the subject (road surface) and external light can be minimized, and the object can be detected only by the light from the light source 21 (headlight).

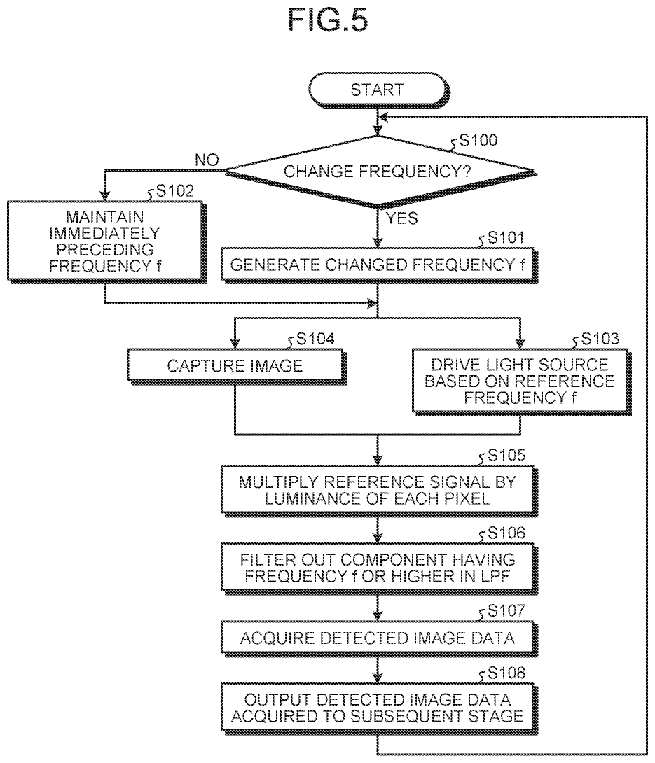

FIG. 5 is a flowchart illustrating an example of processing in the information processing device 10a according to the first embodiment. In step S100, the control unit 40a determines whether or not to change the frequency f of the reference signal. The change of the frequency f of the reference signal will be described below. In a case in which the control unit 40a determines that the frequency f is to be changed (step S100, “Yes”), the control unit 40a shifts the processing to step S101.

In step S101, the control unit 40a changes the frequency f to a predetermined frequency and generates a reference signal having the changed frequency f. The control unit 40a supplies the generated reference signal to the multiplier 101 and the driving unit 22a.

On the other hand, in a case in which the control unit 40a determines in step S100 that the frequency f of the reference signal is not changed, the control unit 40a shifts the processing to step S102. In step S102, the control unit 40a maintains the immediately preceding frequency f and generates a reference signal having this frequency f. The control unit 40a supplies the generated reference signal to the multiplier 101 and the driving unit 22a.

After the processing in step S101 or step S102, the processing is shifted to steps S103 and S104, which are executed in parallel.

In step S103, the driving unit 22a drives the light source 21 in accordance with the reference signal generated and supplied by the control unit 40a in step S101 or S102. Here, as described above, the driving unit 22a drives the light source 21 in accordance with the reference signal by a sine wave or a PWM wave having as a high fundamental frequency as can be regarded as a pseudo sine wave in one frame. Note that it is assumed that the frequency f of the reference signal is a frequency corresponding to a plurality of frames. That is, images of a plurality of frames are captured by the image sensor 20 in one cycle of the reference signal.

In step S104, the image sensor 20 executes image capturing, and image data obtained by the image capturing is supplied to the multiplier 101.

Subsequently, in step S105, for respective pixels, R (red), G (green), and B (blue), for example, of the image data captured in step S104, the processing unit 30a calculates the product of the reference signal by the luminance value of each of the respective pixels by means of the multiplier 101. The multiplier 101 calculates the product of the component of the reference signal corresponding to the frame of the image data captured in step S104 by the luminance value of each of the pixels of the image data.

Subsequently, in step S106, the processing unit 30a filters out a component of the reference signal having the frequency f or higher from the calculation result in step S104 by means of the LPF 102. The output of the LPF 102 is detected image data into which the image data is synchronously detected. In this manner, the processing unit 30a acquires the detected image data into which the image data captured by the image sensor 20 is synchronously detected (step S107).

Subsequently, in step S108, the information processing device 10a outputs the detected image data acquired by the processing unit 30a to the subsequent stage. For example, the information processing device 10a outputs the detected image data to image-recognition-related processing. As described above, the detected image data is image data based on the intensity of the reflected light of the light from the light source 21 having the frequency f, has almost no other disturbance components, and is high S/N data. Therefore, highly accurate image recognition processing is achieved.

When the detected image data is output in step S108, the processing returns to step S100.

Here, the change of the frequency f of the reference signal in step S100 will be described. In a case in which a plurality of vehicles to which the information processing device 10a according to the first embodiment is applied approach each other, the light emitted from the light source 21 (headlight) of each of the vehicles and modulated with the frequency f interferes with the other light, which may make the synchronous detection difficult.

Therefore, in the first embodiment, the frequency f of the reference signal is hopped with a constant cycle. Also, the frequency and the timing for hopping are determined based on information unique to the information processing device 10a or the movable body (vehicle) on which the information processing device 10a is mounted, for example. As a result, it is possible to avoid interference of the light from the light source 21 of the own vehicle with the light from the light source 21 of another vehicle.

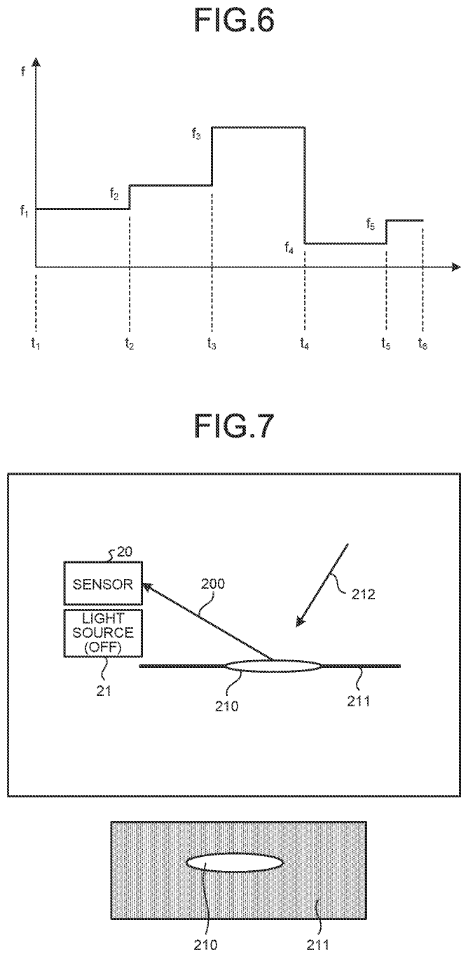

FIG. 6 is a diagram illustrating an example of the change of the frequency f of the reference signal applicable to the first embodiment. In FIG. 6, the horizontal axis represents time t, and the vertical axis represents the frequency f.

In the example in FIG. 6, a period from time t₁ to time t₆ is set as one cycle, and during this cycle, the frequency f of the reference signal is changed to a frequency f₁ in a period from the time t₁ to the time t₂, a frequency f₂ in a period from the time t₂ to the time t₃, a frequency f₃ in a period from the time t₃ to the time t₄, a frequency f₄ in a period from the time t₄ to the time t₅, and a frequency f₅ in a period from the time t₅ to the time t₆.

Information about the change pattern and the change timing of the frequency f can be determined based on unique information unique to the information processing device 10a or the vehicle on which the information processing device 10a is mounted. As for the unique information, the possibility that the unique information is matched with unique information of another vehicle can be reduced to almost zero by applying a hash value calculated by an algorithm such as secure hash algorithm (SHA)-1 and SHA-256 to a vehicle body ID (license plate information or the like) of the vehicle, for example. Instead of this, a random number having a predetermined number of digits or the license plate information itself may be used as the unique information.

The control unit 40a can create and store the change pattern and the change timing of the frequency f in advance based on the unique information. Instead of this, the control unit 40a may store only the unique information and generate the change pattern and the change timing of the frequency f based on the unique information each time.

### Second Embodiment

Next, a second embodiment will be described. In the second embodiment, a region of total internal reflection on the road surface is detected by the optical axis of the image sensor 20 and the light source 21 whose optical axes are aligned as much as possible. The region of total internal reflection on the road surface is considered to be a region with high smoothness.

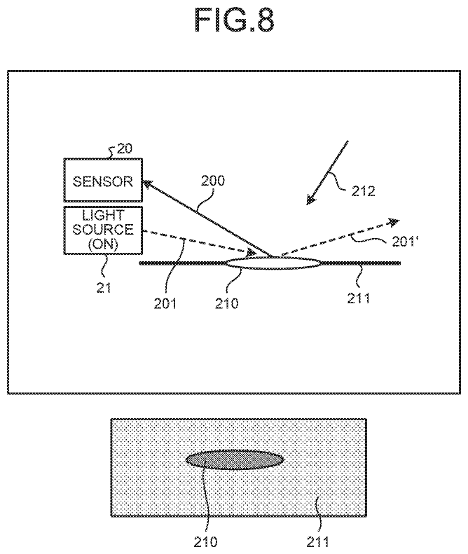

Detection of a total internal reflection region according to the second embodiment will schematically be described with reference to FIGS. 7 and 8. In FIGS. 7 and 8, a puddle 210 on a road surface 211 is defined as a total internal reflection region to be detected. Also, in FIGS. 7 and 8, it is assumed that the optical axis of the image sensor 20 and the optical axis of the light source 21 (headlight) are substantially aligned.

FIG. 7 illustrates an example in a case in which the light source 21 is in an off state. In a case in which the light source 21 is in an off state, external light 212 such as sunlight is applied to the puddle 210 and the road surface 211, and reflected light 200 thereof is received in the image sensor 20 and an image is captured, as illustrated on the upper side of FIG. 7. The captured image is an image in which the puddle 210 is brighter (more whitish) than the surrounding road surface 211 due to the reflection of the external light 212, as schematically illustrated on the lower side of FIG. 7.

FIG. 8 illustrates an example in a case in which the light source 21 is in an on state. In a case in which the light source 21 is in an on state, light 201 emitted from the light source 21 is totally reflected on the surface of the puddle 210 depending on the angular relationship between the light 201 and the surface of the puddle 210 (light 201′). On the other hand, the light 201 is emitted to the road surface 211 as well. In a case in which the road surface 211 is asphalt, for example, the light 201 is diffusely reflected on the road surface 211, and part of the light is received in the image sensor 20. Therefore, the captured image is an image in which the puddle 210 is darker (more blackish) than the surrounding road surface 211, as schematically illustrated on the lower side of FIG. 8.

By deriving a difference between the image when the light source 21 is in an on state and the image when the light source 21 is in an off state, the region of the puddle 210, which is the total internal reflection region, can be detected. That is, the region of total internal reflection on the road surface 211 can be detected based on the difference between the image when the light source 21 is in an on state and the image when the light source 21 is in an off state. Such a region of total internal reflection is a region with high smoothness, and it can be considered that this is a region having a low friction coefficient. Considered as a region of total internal reflection or with high reflectance on the road surface 211 is a region made of metal, such as a manhole and a metal plate laid on the road surface during construction under the road. Accordingly, by detecting the total internal reflection region on the road surface 211, it is possible to perform object measurement on the assumption that a friction coefficient μ in the region is low.

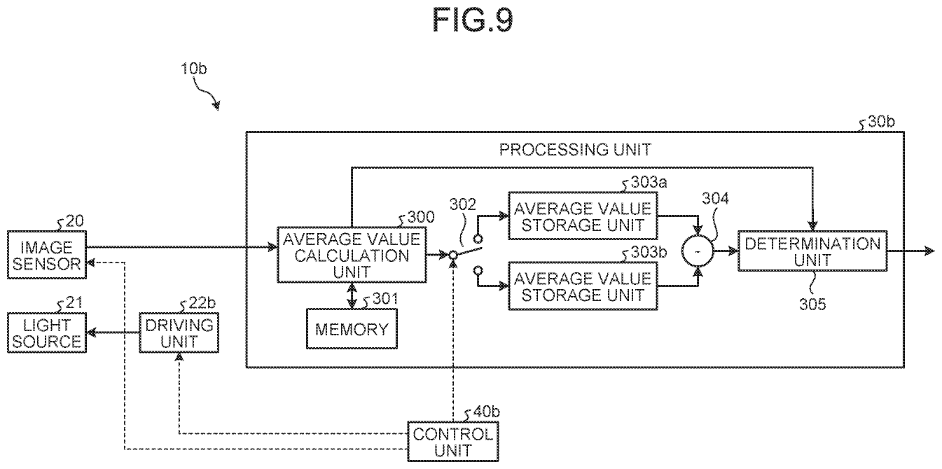

FIG. 9 is a block diagram illustrating an example of a configuration of an information processing device according to the second embodiment. In an information processing device 10b illustrated in FIG. 9, a processing unit 30b includes an average value calculation unit 300, a memory 301, a switch unit 302, average value storage units 303a and 303b, a subtractor 304, and a determination unit 305. The average value calculation unit 300 stores image data output from the image sensor 20 in the memory 301 and calculates an average luminance value in one frame of the image data stored in the memory 301. The average luminance value calculated by the average value calculation unit 300 is stored in either the average value storage unit 303a or 303b via the switch unit 302.

The subtractor 304 outputs a difference between the average luminance value stored in the average value storage unit 303a and the average luminance value stored in the average value storage unit 303b, for example. The determination unit 305 determines a total internal reflection region included in the image data stored in the memory 301 by the average value calculation unit 300 based on the difference output from the subtractor 304 and adds a total internal reflection region attribute to a pixel determined as the total internal reflection region.

Note that the total internal reflection referred here includes reflection with reflectance obtained by adding a predetermined margin to 100% reflectance.

In the information processing device 10b illustrated in FIG. 9, a control unit 40b controls timing of turn-on and turn-off of the light source 21 via a driving unit 22b and controls image capturing timing of the image sensor 20. For example, the control unit 40b takes control so that the image sensor 20 captures an image when the control unit 40b causes the light source 21 to be in an on state and when the control unit 40b causes the light source 21 to be in an off state.

The control unit 40b also controls the switch unit 302 included in the processing unit 30b. More specifically, in a case in which the control unit 40b causes the light source 21 to be in an on state, the control unit 40b selects the average value storage unit 303a in the switch unit 302, for example. On the other hand, in a case in which the control unit 40b causes the light source 21 to be in an off state, the control unit 40b selects the average value storage unit 303b in the switch unit 302, for example. Therefore, the average value storage unit 303a stores an average luminance value of the image data captured by the image sensor 20 while the light source 21 is in an on state. Also, the average value storage unit 303b stores an average luminance value of the image data captured by the image sensor 20 while the light source 21 is in an off state.

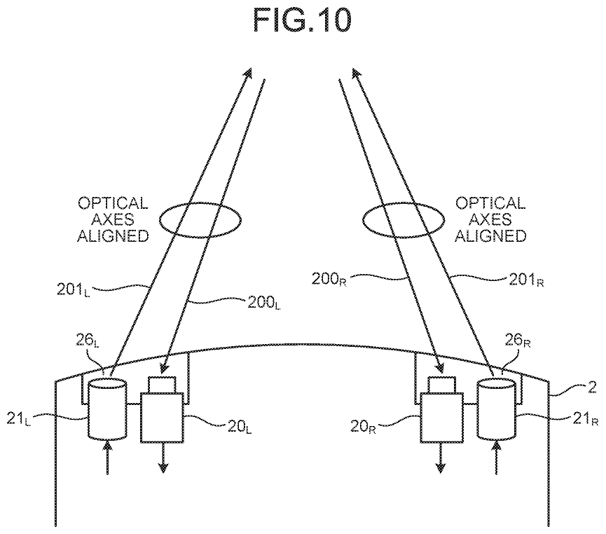

FIG. 10 is a diagram illustrating an example of arrangement of the light source 21 (headlight) and the image sensor 20 according to the second embodiment. In the example in FIG. 10, image sensors 20_{L} and 20_{R} are arranged in headlight boxes 26_{L} and 26_{R} that house left and right headlights, that is, light sources 21_{L} and 21_{R}, respectively, on the front surface of the vehicle 2. The light source 21_{L} and the image sensor 20_{L} are paired up and controlled in terms of turn-on, turn-off, and image capturing. Similarly, the light source 21_{R} and the image sensor 20_{R} are paired up and controlled in terms of turn-on, turn-off, and image capturing.

Also, the light source 21_{L} and the image sensor 20_{L} are arranged so that the optical axis of light 201_{L} emitted from the light source 21_{L} and the optical axis of reflected light 200_{L} received by the image sensor 20_{L} are substantially aligned. Similarly, the light source 21_{R} and the image sensor 20_{R} are arranged so that the optical axis of light 201_{R} emitted from the light source 21_{R} and the optical axis of reflected light 200_{R} received by the image sensor 20_{R} are substantially aligned.

Note that, in FIG. 10, although the image sensor 20 and the light source 21 (headlight) according to the second embodiment are arranged in each of the headlight boxes 26_{L} and 26_{R} on each side of the front surface of the vehicle 2, the arrangement is not limited to one in this example. The image sensor 20 and the light source 21 according to the second embodiment may be arranged only in one of the headlight boxes 26_{L} and 26_{R} or may be arranged at a position other than the headlight boxes 26_{L} and 26_{R}, for example.

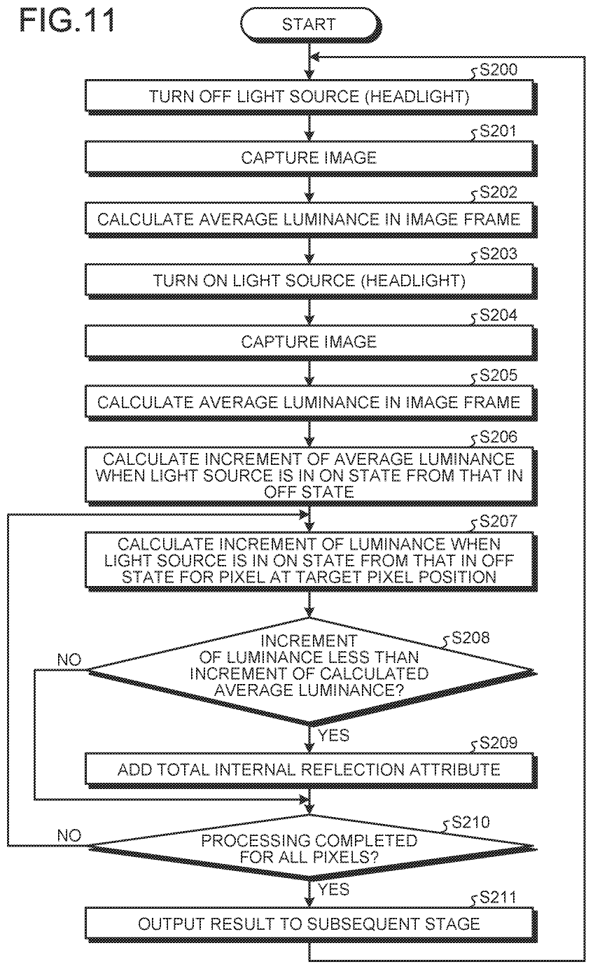

FIG. 11 is a flowchart of an example illustrating processing according to the second embodiment. In step S200, the control unit 40b turns off the light source 21 via the driving unit 22b. Subsequently, in step S201, the control unit 40b issues an image capturing instruction to the image sensor 20. Also, the control unit 40b controls the switch unit 302 so that the switch unit 302 selects the average value storage unit 303b. Subsequently, in step S202, the processing unit 30b calculates an average luminance value of the image data output from the image sensor 20 by means of the average value calculation unit 300. The average luminance value of the image data when the light source 21 is in an off state calculated by the average value calculation unit 300 is stored in the average value storage unit 302b via the switch unit 302. Also, in step S202, the average value calculation unit 300 stores the image data output from the image sensor 20 in the memory 301.

Subsequently, in step S203, the control unit 40b turns on the light source 21 via the driving unit 22b. Subsequently, in step S204, the control unit 40b issues an image capturing instruction to the image sensor 20. Also, the control unit 40b controls the switch unit 302 so that the switch unit 302 selects the average value storage unit 303a. Subsequently, in step S205, the processing unit 30b calculates an average luminance value of the image data output from the image sensor 20 by means of the average value calculation unit 300. The average luminance value of the image data when the light source 21 is in an on state calculated by the average value calculation unit 300 is stored in the average value storage unit 302a via the switch unit 302. Also, in step S205, the average value calculation unit 300 stores the image data output from the image sensor 20 in the memory 301.

Subsequently, in step S206, the processing unit 30b subtracts, by means of the subtractor 304, the average luminance value of the image data when the light source 21 is in an off state stored in the average value storage unit 302b from the average luminance value of the image data when the light source 21 is in an on state stored in the average value storage unit 302a. The value output from the subtractor 304 is an increment of the average luminance value of the image data when the light source 21 is in an on state from the average luminance value of the image data when the light source 21 is in an off state.

Subsequently, in step S207, the determination unit 305 in the processing unit 30b calculates an increment of luminance when the light source 21 is in an on state from luminance in an off state for a pixel at a target pixel position in each piece of image data when the light source 21 is in an on state and in an off state stored in the memory 301 in step S202 and in step S205.

Subsequently, in step S208, the determination unit 305 determines whether or not the increment of the luminance obtained in step S207 is less than the increment of the average luminance value obtained in step S206. In a case in which the determination unit 305 determines that the increment of the luminance is equal to or more than the increment of the average luminance value (step S208, “No”), the determination unit 305 shifts the processing to step S210.

On the other hand, in a case in which the determination unit 305 determines that the increment of the luminance is less than the increment of the average luminance value (step S208, “Yes”), the determination unit 305 shifts the processing to step S209. In step S209, the determination unit 305 adds a total internal reflection attribute to the target pixel included in the image data captured when the light source 21 is in an on state, for example.

Subsequently, in step S210, the determination unit 305 in the processing unit 30b determines whether or not the processing in steps S207 to S209 has been completed for all of the pixels included in the image data. In a case in which it is determined that the processing has not been completed (step S210, “No”), the determination unit 305 designates another pixel (for example, an adjacent pixel) as a new target pixel and executes the processing in step S207 and the subsequent steps.

In a case in which it is determined in step S210 that the processing has been completed for all of the pixels (step S210, “Yes”), the determination unit 305 shifts the processing to step S211. In step S211, the information processing device 10b outputs the image data captured when the light source 21 is in an on state, to which the total internal reflection attribute is added by the processing unit 30b, to the subsequent stage. The information processing device 10b outputs the image data to which the total internal reflection attribute is added to a travel control system of the vehicle 2 on which the information processing device 10b is mounted, for example.

When the processing in step S211 is completed, the processing is returned to step S200.

Consequently, the travel control system of the vehicle 2 can recognize that a region with high smoothness (region having a low friction coefficient μ) exists in front of the traveling vehicle 2 before reaching the region. Accordingly, the travel control system of the vehicle 2 can easily execute travel control in accordance with the characteristics of the region and can achieve safe travel and a comfortable ride in the vehicle 2.

### Third Embodiment

Next, a third embodiment will be described. In the third embodiment, information in the height direction on the road surface can be obtained by separating the optical axis of the light source 21 from the optical axis of the image sensor 20, projecting a specific pattern on the road surface by means of the light source 21, and using an image of the pattern captured by the image sensor 20.

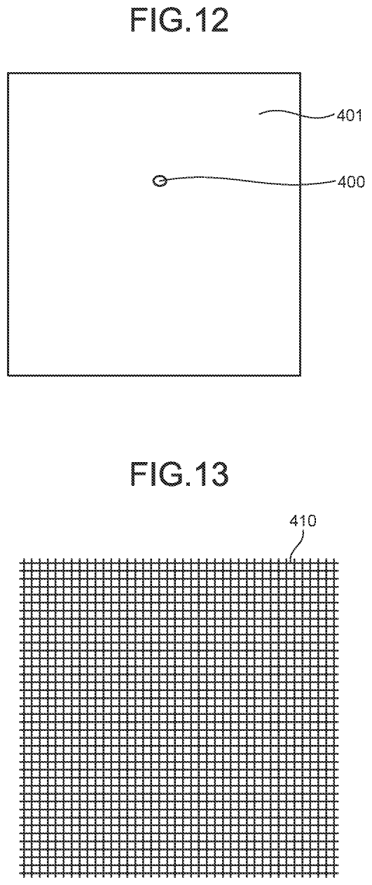

Description will be provided using a specific example. FIG. 12 illustrates an example of a captured image of a state in which a small object 400 is on a white flat surface 401. With only the image in FIG. 12, information about the small object 400 in the height direction can be acquired only with lower accuracy than information in the horizontal direction (width and the like).

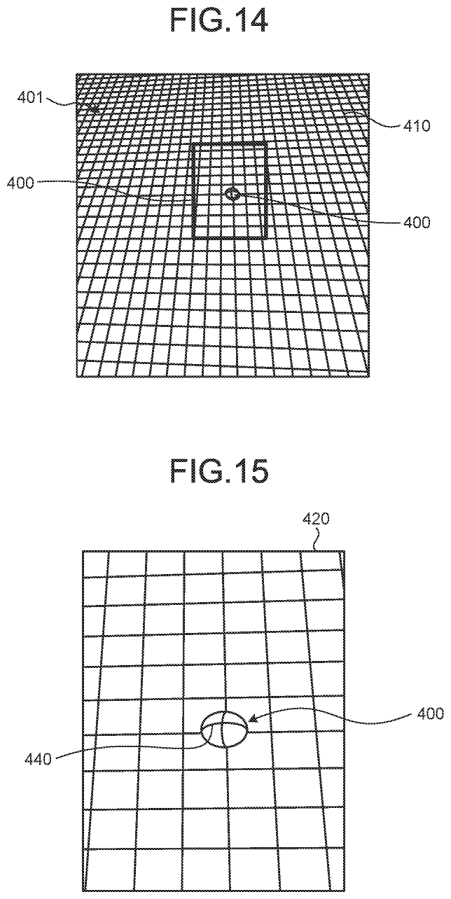

Here, consider a case in which an image pattern 410 (grid pattern in this example) as illustrated in FIG. 13 is projected onto the flat surface 401 and is captured. FIG. 14 illustrates an example of an image captured in an oblique direction from the near side by projecting the image pattern 410 from substantially directly above the flat surface 401 including the small object 400. Also, FIG. 15 is an enlarged view of a region 420 including the small object 400 in FIG. 14. As illustrated in FIGS. 14 and 15, in a case in which the image capturing direction and the projection direction of the image pattern 410 are different, a portion 440 of the projected image pattern 410 covering the small object 400 is captured to be displaced on the small object 400 due to the parallax in accordance with the height of the surface of the small object 400 from the flat surface 401. Based on this displacement, the information about the small object 400 in the height direction can be obtained with high accuracy.

Here, in a case in which the projection direction of the image pattern 410 and the image capturing direction match, displacement of the image pattern 410 on the small object 400 does not occur on the image based on the image capturing data. Therefore, arrangement of the light source 21 and the image sensor 20 is set so that the direction of the optical axis of the light source 21 and the direction of the optical axis of the image sensor 20 form an angle θ having a predetermined value or higher. Also, in a case of obtaining information in the height direction on the road surface which is a subject surface, the light source 21 and the image sensor 20 are preferably arranged at different positions in the height direction.

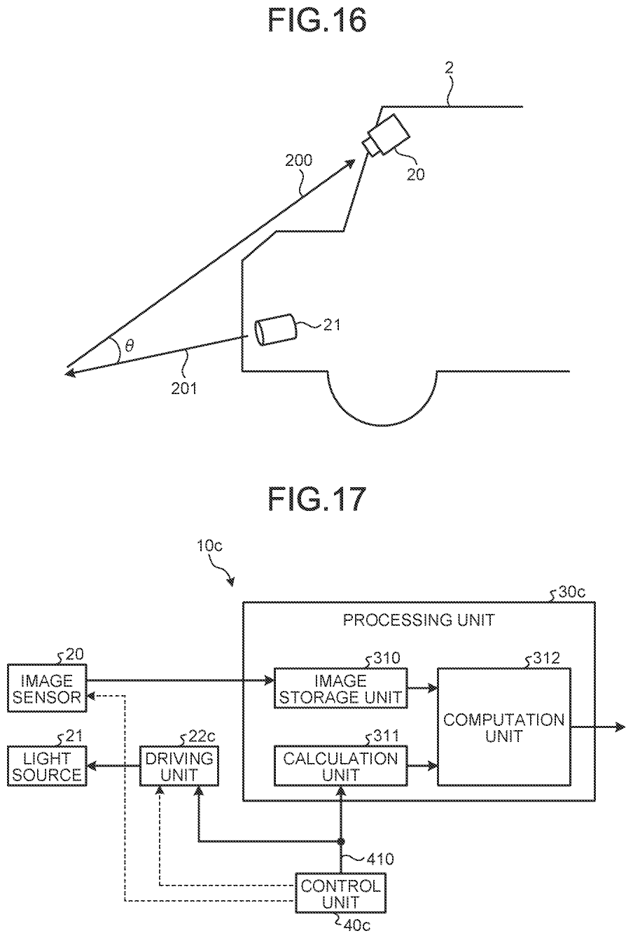

FIG. 16 is a diagram illustrating an example of arrangement of the light source 21 and the image sensor 20 according to the third embodiment. In the example in FIG. 16, the light source 21 is provided at a lower part of the front of the vehicle 2, and the image sensor 20 is provided at a position corresponding to an upper part of the windshield. In the light source 21 and the image sensor 20, the light 201 emitted from the light source and the reflected light 200 obtained as the light 201 is reflected on the subject surface and is received in the image sensor 20 form the angle θ having a predetermined value or higher.

FIG. 17 is a block diagram illustrating an example of a configuration of an information processing device 10c according to the third embodiment. In FIG. 17, a processing unit 30c includes an image storage unit 310, a calculation unit 311, and a computation unit 312. Also, a control unit 40c outputs the image pattern 410 to a driving unit 22c and the calculation unit 311 and controls image capturing timing of the image sensor 20. The driving unit 22c drives the light source 21 in accordance with the image pattern 410 output from the control unit 40c.

Here, the light source 21 can include a digital micromirror device (DMD), for example. The DMD is an array of a large number of micromirror surfaces arranged on a flat surface. By irradiating the DMD with light and controlling each of these many micromirror surfaces in accordance with the image data, an image based on the image data can be projected by reflected light of the irradiated light. Digital light processing (DLP) (registered trademark) can be applied as an example of such a light source 21.

The image pattern 410 is stored in advance in a memory (the storage 3003, the ROM 3001, or the like) included in the information processing device 10c, for example. Instead of this, the image pattern 410 may be generated by the control unit 40c in accordance with a program. Here, the control unit 40c can output a plurality of types of image pattern 410. For example, in a case in which the image pattern 410 is the grid pattern illustrated in FIG. 13, the control unit 40c can output a plurality of image patterns 410 having different grid sizes.

Based on the image pattern 410 output from the control unit 40c, the calculation unit 311 derives by means of calculation a virtual image that would be obtained if the image pattern 410 were projected onto the road surface assumed to be completely flat by the light source 21, and the projected image pattern 410 were captured by the image sensor 20. The calculation unit 311 supplies the calculated image data based on the virtual image to the computation unit 312. The image data calculated by the calculation unit 311 is theoretical data that can be calculated from known fixed values such as the angles of the respective optical axes of the light source 21 and the image sensor 20 to the road surface and a parameter of the image pattern 410 (in a case of a grid pattern, grid spacing). Hereinbelow, the image data based on the virtual image calculated by the calculation unit 311 will be referred to as theoretical image data.

The image storage unit 310 stores image data captured by the image sensor 20. The computation unit 312 obtains information in the height direction on the road surface based on the image data stored in the image storage unit 310 and the theoretical image data supplied from the calculation unit 311.

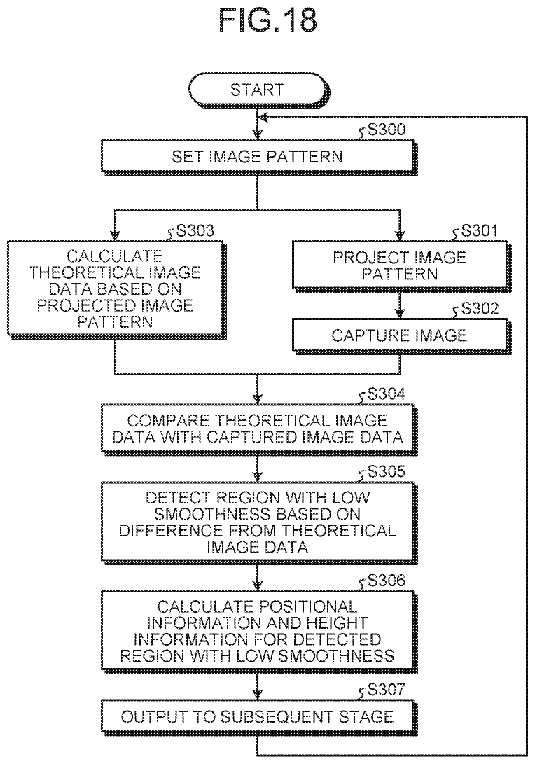

FIG. 18 is a flowchart of an example illustrating processing according to the third embodiment. In step S300, the control unit 40c sets the image pattern 410 to be projected.

As described above, in a case in which the image pattern 410 is the grid pattern illustrated in FIG. 13, the grid spacing can be applied as a parameter. In this case, by periodically changing the grid spacing in the image pattern 410, it is possible to deal with various sizes of object to be measured. For example, in a case in which the grid spacing when the image pattern 410 is projected onto the road surface is 3 cm, parallax may not be able to be observed for an object to be measured smaller than the grid spacing. In this case, by setting the grid spacing of the projected image pattern 410 to 1 cm, the parallax can highly possibly be observed.

In this example, the control unit 40c sets the grid spacing in the image pattern 410 to a predetermined value in step S300. The control unit 40c supplies the image pattern 410 set in accordance with the parameter to the driving unit 22c and the calculation unit 311.

After the processing in step S300, the processing is shifted to steps S301 and S303, which can be executed in parallel. In step S301, the control unit 40c instructs the driving unit 22c to drive the light source 21 in accordance with the image pattern 410 supplied in step S300. The driving unit 22c drives the light source 21 in response to this instruction and causes the light source 21 to project the image pattern 410 onto the road surface.

Subsequently, in step S302, the control unit 40c instructs the image sensor 20 to capture an image. The image sensor 20 captures an image of the road surface on which the image pattern 410 is projected in response to this instruction. The image sensor 20 supplies the image data including the captured image of the image pattern 410 to the processing unit 30c to cause the image data to be stored in the image storage unit 310.

On the other hand, in step S303, the calculation unit 311 calculates theoretical image data based on the image pattern 410 supplied from the control unit 40c in step S300 and supplies the calculated theoretical image data to the computation unit 312.

When the processing in step S302 and step S303 is completed, the processing is shifted to step S304. In step S304, the computation unit 312 compares the theoretical image data calculated in step S303 with the image data captured in step S302 and extracts the difference between the theoretical image data and the captured image data. Subsequently, in step S305, the computation unit 312 detects a region with low smoothness in the captured image data based on the difference extracted in step S304. For example, the computation unit 312 detects a region in which the difference is equal to or higher than a predetermined value as a region with low smoothness.

Subsequently, in step S306, the computation unit 312 obtains, for the region detected as one with low smoothness in step S305, positional information indicating the position of the region and height information indicating the height of the region.

The computation unit 312 calculates the positional information indicating a relative position of the region to the position of the image sensor 20 based on information such as the angle of view of the image sensor 20, the angle of the optical axis, and the parameter (grid spacing) of the image pattern 410, for example. Instead of this, the computation unit 312 can obtain the positional information as information indicating a position in the image data, for example.

Also, the computation unit 312 calculates the height information based on the displacement amount of the portion of the image pattern 410 included in the region in the captured image data from the portion of the image pattern 410 included in the region in the theoretical image data.

Subsequently, in step S307, the information processing device 10c outputs the positional information and the height information of the region with low smoothness calculated in the step S306 to the subsequent stage. The information processing device 10c outputs the positional information and the height information of the region with low smoothness to a travel planning system of the vehicle 2 on which the information processing device 10c is mounted, for example.

When the processing in step S307 is completed, the processing is returned to step S300, the image pattern 410 whose grid spacing is different from the previous one is set, and the processing in step S300 and the subsequent steps is executed.

In this manner, in the third embodiment, the flatness in front of the vehicle 2 in the traveling direction can be recognized based on the image data captured by the image sensor 20, for example. Accordingly, the travel planning system of the vehicle 2 can formulate a travel plan in accordance with the flatness in front of the vehicle 2 in the traveling direction and can achieve safe travel and a comfortable ride in the vehicle 2.

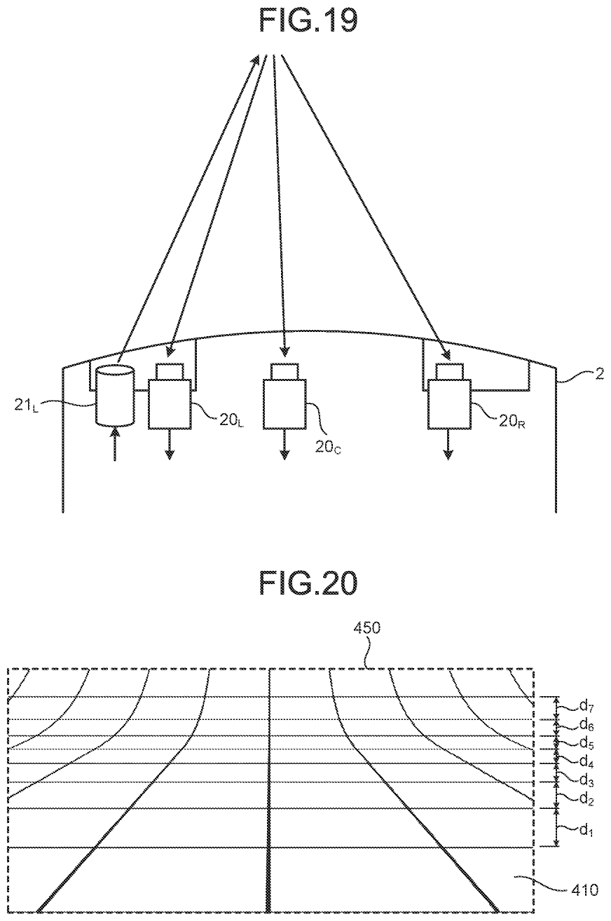

Note that, in the above description, although one image sensor 20 is used for one light source 21 as illustrated in FIG. 16, the number of the image sensors 20 is not limited to that in this example. That is, a plurality of image sensors 20 may be applied to one light source 21. FIG. 19 is a diagram illustrating an example in which three image sensors 20_{L}, 20_{R} and 20_{C} are applied to one light source 21_{L}. In this example, the light source 21_{L} and the image sensor 20_{L} are housed in the headlight box on the left side of the vehicle 2, and the image sensor 20_{R} is housed in the headlight box on the right side of the vehicle 2. Also, the image sensor 20_{C} is arranged at a position corresponding to the upper part of the windshield and at the center of the front surface of the vehicle 2 in a similar manner to the image sensor 20 illustrated in FIG. 16.

In the case of this example, images of the image pattern 410 projected on the road surface by the light source 21_{L} are captured by each of the image sensors 20_{L}, 20_{R}, and 20_{C}. Also, respective pieces of theoretical image data corresponding to these image sensors 20_{L}, 20_{R}, and 20_{C} are calculated. By using the respective pieces of image data captured by the respective image sensors 20_{L}, 20_{R}, and 20_{C} and the respective pieces of theoretical image data corresponding to the respective image sensors 20_{L}, 20_{R}, and 20_{C} in combination, a region with low flatness and height information in the region can be obtained with higher accuracy.

### Application Example of Third Embodiment

Next, an application example of the third embodiment will be described. Although a region with low flatness on the road surface is detected by projecting the image pattern 410 onto the road surface by the light source 21 in the above description, inclination of the road surface in front of the vehicle 2 in the traveling direction can be detected by projecting the image pattern 410 onto the road surface. For example, the image sensor 20 captures the image pattern 410 projected on the road surface. For example, in the processing unit 30c, the computation unit 312 detects inclination of the road surface based on the distortion in the vertical direction in the image based on the captured image data.

The application example of the third embodiment will be described more specifically with reference to FIG. 20. For example, the grid pattern illustrated in FIG. 13 is used as the image pattern 410, and the image pattern 410 with the grid pattern is projected onto the road surface by the light source 21. An image of the road surface on which the image pattern 410 is projected is captured by the image sensor 20, and the curvature of the grid lines in the vertical direction is examined in an image 450 based on the captured image data. In the example in FIG. 20, there is a range in which the angles of the grid lines on both sides of the grid line at the central portion of the image 450 change in the vertical direction. It can be determined that, in the range in which the angles change, inclination of an ascending slope of the road surface starts. In a case of inclination of a descending slope, the angles change in the horizontal direction. In this manner, by examining the change in the curvature of the grid in the vertical direction, it is possible to determine whether the road surface has inclination of an ascending slope or inclination of a descending slope.

Instead of this, the inclination of the road surface can also be detected by examining distances d₁, d₂, . . . , d₇ of the grids in the vertical direction in the image 450. For example, in a case in which the distances d₁, d₂, . . . , d₇ are approximately equal, it can be determined that the road surface is not inclined in a range in which the image pattern 410 is projected. On the other hand, in the example in FIG. 20, the grid distance is gradually shorter from the distance d₁ to the distance d₅, and the grid distance is gradually longer from the distance d₅ to the distance d₇. Also, the grids of the image pattern 410 are included up to the upper end of the image 450. In this case, it can be determined that inclination of an ascending slope starts in the range of the distances d₃ to d₆, in which the grid distances are short. Meanwhile, it is considered that, in a case of inclination of a descending slope, the grids of the image pattern 410 are not included at the upper end portion of the image 450.

In this manner, based on the image data obtained by capturing the image pattern 410 projected on the road surface by means of the image sensor 20, it is possible to determine whether or not there is inclination in front of the traveling vehicle 2 on the road surface. Accordingly, for example, the travel control system of the vehicle 2 can easily execute travel control in accordance with the inclination and can achieve safe travel and a comfortable ride in the vehicle 2.

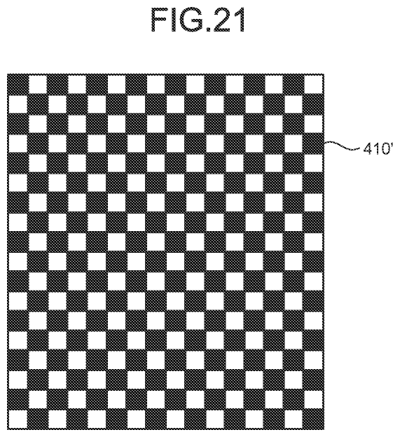

Note that, in the above description, although the image pattern 410 is the grid pattern illustrated in FIG. 13, the pattern is not limited to one in this example. For example, as illustrated in FIG. 21, a so-called checkered image pattern 410′ can be used in which a black region and a white region are alternately repeated in the vertical and horizontal directions. In the image pattern 410′, the black region is a region that is not irradiated with light (masked), and the white region is a region that is irradiated with light, for example. With this checkered image pattern 410′, it is possible to obtain a substantially similar effect as in the case of using the aforementioned grid image pattern 410.

### Fourth Embodiment

Next, a fourth embodiment will be described. In the above description, the processing according to the first embodiment, the processing according to the second embodiment, and the processing according to the third embodiment are executed independently. In the fourth embodiment, the processing according to the first embodiment, the processing according to the second embodiment, and the processing according to the third embodiment are executed as a sequence of processing.

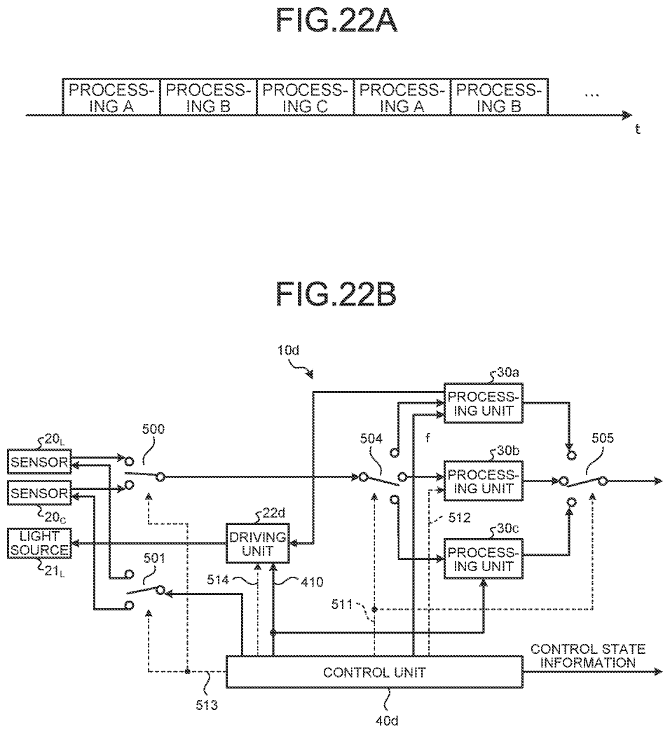

Processing according to the fourth embodiment will be described more specifically with reference to FIGS. 22A and 22B. Here, the processing according to the first embodiment is referred to as processing A, the processing according to the second embodiment is referred to as processing B, and the process according to the third embodiment is referred to as processing C. The processing A, the processing B, and the processing C are repeatedly executed in a predetermined order, for example, as illustrated in FIG. 22A.

FIG. 22B is a block diagram illustrating an example of a configuration that enables the processing according to the fourth embodiment to be executed. In FIG. 22B, an information processing device 10d includes the processing unit 30a according to the first embodiment, the processing unit 30b according to the second embodiment, the processing unit 30c according to the third embodiment, and switch units 504 and 505.

The switch unit 504 is supplied at an input terminal thereof with image data provided by either the image sensor 20_{L} or the image sensor 20_{C} via a switch unit 500. The three output terminals of the switch unit 504 are connected to the processing units 30a, 30b, and 30c, respectively. Also, the switch unit 505 is supplied at three input terminals thereof with outputs of the processing units 30a, 30b, and 30c, respectively. The output of any of the processing units 30a, 30b, and 30c is output to the outside from the output terminal of the switch unit 505. The switch units 504 and 505 are switched synchronously by a control signal 511 output from a control unit 40d.

The control unit 40d includes the functions of the control unit 40a according to the first embodiment, the control unit 40b according to the second embodiment, and the control unit 40c according to the third embodiment described above. Similarly, a driving unit 22d includes the functions of the driving unit 22a according to the first embodiment, the driving unit 22b according to the second embodiment, and the driving unit 22c according to the third embodiment. The function of the driving unit 22d is switched to the functions of the driving units 22a, 22b, and 22c in the processing A, B, and C under the control of the control unit 40d, respectively.

Also, in FIG. 22B, the light source 21_{L} and the image sensor 20_{L} are housed in the headlight box on the left side of the vehicle 2 with their optical axes substantially aligned with each other. Also, the image sensor 20_{C} is provided at a position corresponding to the upper part of the windshield of the vehicle 2 so that the direction of the optical axis of the image sensor 20_{C} forms the angle θ having a predetermined value or higher with the direction of the optical axis of the light source 21_{L}.

The outputs of the image sensors 20L and 20C are supplied to the two input terminals of the switch unit 500, respectively. The output of the switch unit 500 is connected to the input terminal of the switch unit 504. In the input terminal of a switch unit 501 is input an image capturing instruction from the control unit 40d. The two output terminals of the switch unit 501 are connected to the image sensors 20_{L} and 20_{C}, respectively. The switch units 500 and 501 are switched synchronously by a control signal 513 output from the control unit 40d.

Operations of the processing A, the processing B, and the processing C in such a configuration will be described. In the processing A, the control unit 40d supplies the frequency f of the reference signal to the processing unit 30a. The reference signal having the frequency f is supplied from the processing unit 30a to the driving unit 22d. Also, in the processing A, the control unit 40d takes control so that the image sensor 20_{L} is selected in the switch units 500 and 501 and takes control so that the processing unit 30a is selected in the switch units 504 and 505.

In the processing B, the control unit 40d takes control so that the image sensor 20_{L} is selected in the switch units 500 and 501 and takes control so that the processing unit 30b is selected in the switch units 504 and 505. Also, during the period of the processing B, the control unit 40d takes control by means of a control signal 512 so that the switch unit 302 (refer to FIG. 9) selects the average value storage units 303a and 303b alternately and controls the driving unit 22d by means of a control signal 514 synchronously with selection of the switch unit 302 to control timing of turn-on and turn-off of the light source 21_{L}.

In the processing C, the control unit 40d takes control so that the image sensor 20_{C} is selected in the switch units 500 and 501 and takes control so that the processing unit 30c is selected in the switch units 504 and 505. Also, in the processing C, the control unit 40d supplies the image pattern 410 to the processing unit 30c and the driving unit 22d.

Meanwhile, the control unit 40d outputs control state information indicating which of the processing A, the processing B, and the processing C is currently being executed.

In the fourth embodiment, by controlling each unit in this manner, the processing A according to the first embodiment, the processing B according to the second embodiment, and the processing C according to the third embodiment can be regarded as a sequence of processing and can be executed sequentially in a repetitive manner by common hardware. As a result, in the fourth embodiment, the effects of the first embodiment, the second embodiment, and the third embodiment described above can be obtained.

### Fifth Embodiment

Next, a fifth embodiment will be described. The fifth embodiment is an example in which any of the above-mentioned first embodiment, second embodiment, third embodiment, and fourth embodiment is mounted on a vehicle enabling autonomous driving control. Hereinbelow, for illustrative purposes, a configuration including the information processing device 10d, the image sensors 20_{L} and 20_{C}, the light source 21_{L}, the driving unit 22d, and the switch units 500 and 501 described in the above fourth embodiment is applied.

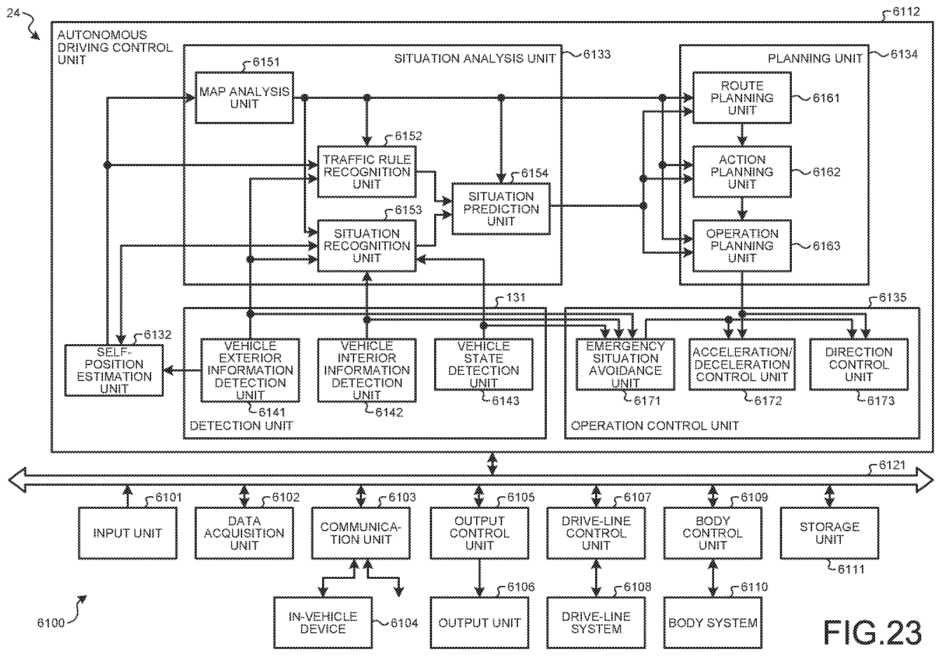

FIG. 23 is a block diagram illustrating a schematic functional configuration example of a system for controlling a vehicle 24 applicable to the fifth embodiment. In FIG. 23, a vehicle control system 6100 is a control system mounted on the vehicle 24 and controlling the operation of the vehicle 24.

Note that, hereinbelow, a vehicle provided with the vehicle control system 6100 is referred to as an own vehicle or an own car in a case in which the vehicle is distinguished from other vehicles.

The vehicle control system 6100 includes an input unit 6101, a data acquisition unit 6102, a communication unit 6103, an in-vehicle device 6104, an output control unit 6105, an output unit 6106, a drive-line control unit 6107, a drive-line system 6108, a body control unit 6109, a body system 6110, a storage unit 6111, and an autonomous driving control unit 6112. The input unit 6101, the data acquisition unit 6102, the communication unit 6103, the output control unit 6105, the drive-line control unit 6107, the body control unit 6109, the storage unit 6111, and the autonomous driving control unit 6112 are interconnected via a communication network 6121.

The communication network 6121 is an in-vehicle communication network or a bus that conforms to an arbitrary standard such as controller area network (CAN), local interconnect network (LIN), local area network (LAN), and FlexRay (registered trademark). Note that the respective units of the vehicle control system 6100 may be connected directly without the communication network 6121.

Note that, hereinbelow, in a case in which the respective units of the vehicle control system 6100 communicate via the communication network 6121, description of the communication network 6121 shall be omitted. For example, in a case in which the input unit 6101 and the autonomous driving control unit 6112 communicate with each other via the communication network 6121, a simple expression that the input unit 6101 and the autonomous driving control unit 6112 communicate with each other is used.

The input unit 6101 includes a device that an occupant uses to input various data, instructions, and the like. For example, the input unit 6101 includes an operation device such as a touch panel, a button, a microphone, a switch, and a lever, and an operation device allowing input by means of a method, other than a manual operation, such as voice and gesture. Also, for example, the input unit 6101 may be a remote control device using infrared rays or other electric waves, or an external connection device such as a mobile device and a wearable device corresponding to the operation of the vehicle control system 6100. The input unit 6101 generates an input signal based on data, an instruction, or the like input by the occupant and supplies the input signal to each of the units of the vehicle control system 6100.

The data acquisition unit 6102 includes various sensors or the like for acquiring data for use in processing of the vehicle control system 6100 and supplies the acquired data to each of the units of the vehicle control system 6100.

For example, the data acquisition unit 6102 includes various sensors for detecting a state of the own vehicle and the like. Specifically, for example, the data acquisition unit 6102 includes a gyro sensor, an acceleration sensor, an inertial measurement unit (IMU), and a sensor for detecting an accelerator pedal operation amount, a brake pedal operation amount, a steering wheel steering angle, engine speed, motor speed, wheel rotation speed, or the like.

Also, for example, the data acquisition unit 6102 includes various sensors for detecting information outside the own vehicle. Specifically, for example, the data acquisition unit 6102 includes an image capturing device such as a time of flight (ToF) camera, a stereo camera, a monocular camera, an infrared camera, and another camera. Also, for example, the data acquisition unit 6102 includes an environmental sensor for detecting weather or a meteorological phenomenon and a surrounding information detection sensor for detecting an object around the own vehicle. The environmental sensor includes a raindrop sensor, a fog sensor, a sunshine sensor, and a snow sensor, for example. The surrounding information detection sensor includes an ultrasonic sensor, a radar, light detection and ranging, laser imaging detection and ranging (LiDAR), and sonar, for example.

Further, for example, the data acquisition unit 6102 includes various sensors for detecting a current position of the own vehicle. Specifically, for example, the data acquisition unit 6102 includes a global navigation satellite system (GNSS) receiver or the like that receives a GNSS signal from a GNSS satellite.

Also, for example, the data acquisition unit 6102 includes various sensors for detecting information in the vehicle. Specifically, for example, the data acquisition unit 6102 includes an image capturing device that captures a driver, a biological sensor that detects the driver's biological information, a microphone that collects voice in the vehicle interior, and the like. The biological sensor is provided on the seat surface or the steering wheel, for example, and detects biological information of the occupant sitting on the seat or the driver holding the steering wheel.

The communication unit 6103 communicates with the in-vehicle device 6104 and various devices, servers, base stations, and the like outside the vehicle, transmits data supplied from each of the units of the vehicle control system 6100, and supplies received data to each of the units of the vehicle control system 6100. A communication protocol that the communication unit 6103 supports is not particularly limited, and the communication unit 6103 can support a plurality of types of communication protocol.

For example, the communication unit 6103 performs wireless communication with the in-vehicle device 6104 by means of a wireless LAN, Bluetooth (registered trademark), near field communication (NFC), wireless USB (WUSB), or the like. Also, for example, the communication unit 6103 performs wired communication with the in-vehicle device 6104 by means of universal serial bus (USB), high-definition multimedia interface (HDMI (registered trademark)), mobile high-definition link (MHL), or the like via a not-illustrated connection terminal (and a cable if necessary).

Further, for example, the communication unit 6103 performs communication with a device (for example, an application server or a control server) existing on an external network (for example, the Internet, a cloud network, or a business-operator-specific network) via a base station or an access point. Further, for example, the communication unit 6103 performs communication with a terminal (for example, a terminal of a pedestrian or a store, or a machine type communication (MTC) terminal) existing in the vicinity of the own vehicle with use of a peer to peer (P2P) technique. Further, for example, the communication unit 6103 performs V2X communication such as communication between vehicles (Vehicle to Vehicle communication), communication between a road and a vehicle (Vehicle to Infrastructure communication), communication between the own vehicle and a house (Vehicle to Home communication), and communication between a pedestrian and a vehicle (Vehicle to Pedestrian communication). Further, for example, the communication unit 6103 is provided with a beacon receiving unit, receives electric waves or electromagnetic waves transmitted from a wireless station or the like installed on the road, and acquires information such as a current position, traffic congestion, traffic regulation, and required time.

The in-vehicle device 6104 includes a mobile device or a wearable device owned by the occupant, an information device carried in or attached to the own vehicle, and a navigation device for searching a route to an arbitrary destination, for example.

The output control unit 6105 controls output of various kinds of information to the occupant of the own vehicle or an outside of the vehicle. For example, the output control unit 6105 generates an output signal including at least one of visual information (for example, image data) and auditory information (for example, audio data) and supplies the output signal to the output unit 6106 to control output of visual information and auditory information from the output unit 6106. Specifically, for example, the output control unit 6105 synthesizes image data captured by different image capturing devices of the data acquisition unit 6102 to generate a bird's-eye view image, a panoramic image, or the like and supplies an output signal including the generated image to the output unit 6106. Also, for example, the output control unit 6105 generates audio data including a warning sound, a warning message, or the like for dangers such as collision, contact, and entry into a danger zone and supplies an output signal including the generated audio data to the output unit 6106.

The output unit 6106 includes a device enabling visual information or auditory information to be output to the occupant of the own vehicle or the outside of the vehicle. For example, the output unit 6106 includes a display device, an instrument panel, an audio speaker, headphones, a wearable device such as a spectacle-type display worn by the occupant, a projector, a lamp, and the like. The display device included in the output unit 6106 may be a device that displays visual information in the driver's field of view, such as a head-up display, a transmissive display, and a device having an augmented reality (AR) display function, instead of a device having a normal display.

The drive-line control unit 6107 generates various control signals and supplies the control signals to the drive-line system 6108 to control the drive-line system 6108. The drive-line control unit 6107 also supplies control signals to each of the units other than the drive-line system 6108 as necessary to notify a control state of the drive-line system 6108.

The drive-line system 6108 includes various devices related to the drive line of the own vehicle. For example, the drive-line system 6108 includes a driving force generation device for generating a driving force such as an internal combustion engine and a driving motor, a driving force transmission mechanism for transmitting the driving force to the wheels, a steering mechanism for adjusting the steering angle, a braking device for generating a braking force, an antilock brake system (ABS), an electronic stability control (ESC), an electric power steering device, and the like.

The body control unit 6109 generates various control signals and supplies the control signals to the body system 6110 to control the body system 6110. The body control unit 6109 also supplies control signals to each of the units other than the body system 6110 as necessary to notify a control state of the body system 6110.

The body system 6110 includes various body devices provided in the vehicle body. For example, the body system 6110 includes a keyless entry system, a smart key system, a power window device, a power seat, a steering wheel, an air conditioner, various lamps (for example, a headlamp, a back lamp, a brake lamp, a winker, and a fog lamp), and the like.

The storage unit 6111 includes a magnetic storage device, a semiconductor storage device, an optical storage device, and a magneto-optical storage device such as a read only memory (ROM), a random access memory (RAM), and a hard disc drive (HDD). The storage unit 6111 stores various programs, data, and the like that each of the units of the vehicle control system 6100 uses. For example, the storage unit 6111 stores map data such as a three-dimensional high-precision map such as a dynamic map, a global map that is less accurate than the high-precision map and covers a wide area, and a local map that includes information around the own vehicle.

The autonomous driving control unit 6112 takes control of autonomous driving such as autonomous traveling and driving assistance. Specifically, for example, the autonomous driving control unit 6112 performs coordinate control for the purpose of fulfilling functions of advanced driver assistance system (ADAS) including collision avoidance or impact mitigation of the own vehicle, follow-up traveling based on an inter-vehicle distance, vehicle speed maintenance traveling, collision warning to the own vehicle, lane departure warning to the own vehicle, and the like. Also, for example, the autonomous driving control unit 6112 performs coordinate control for the purpose of autonomous driving in which autonomous traveling is performed without operation of the driver. The autonomous driving control unit 6112 includes a detection unit 6131, a self-position estimation unit 6132, a situation analysis unit 6133, a planning unit 6134, and an operation control unit 6135.

The detection unit 6131 detects various kinds of information required for control of autonomous driving. The detection unit 6131 includes a vehicle exterior information detection unit 6141, a vehicle interior information detection unit 6142, and a vehicle state detection unit 6143.

The vehicle exterior information detection unit 6141 performs detection processing for information outside the own vehicle based on data or a signal from each of the units of the vehicle control system 6100. For example, the vehicle exterior information detection unit 6141 performs detection processing, recognition processing, and follow-up processing for an object around the own vehicle, and detection processing for a distance to an object. The object to be detected includes a vehicle, a person, an obstacle, a structure, a road, a traffic light, a traffic sign, and a road marking, for example. Also, for example, the vehicle exterior information detection unit 6141 performs detection processing for a surrounding environment around the own vehicle. The surrounding environment to be detected includes weather, a temperature, humidity, brightness, and a road surface state, for example. The vehicle exterior information detection unit 6141 supplies data indicating a result of the detection processing to the self-position estimation unit 6132, a map analysis unit 6151, a traffic rule recognition unit 6152, and a situation recognition unit 6153 of the situation analysis unit 6133, an emergency situation avoidance unit 6171 of the operation control unit 6135, and the like.

The vehicle interior information detection unit 6142 performs detection processing for information inside the own vehicle based on data or a signal from each of the units of the vehicle control system 6100. For example, the vehicle interior information detection unit 6142 performs authentication processing and recognition processing for the driver, detection processing for a state of the driver, detection processing for the occupant, detection processing for an environment inside the vehicle, and the like. The state of the driver to be detected includes a physical condition, a wakefulness level, a concentration level, a fatigue level, and a line-of-sight direction, for example. The environment inside the vehicle to be detected includes a temperature, humidity, brightness, and odor, for example. The vehicle interior information detection unit 6142 supplies data indicating a result of the detection processing to the situation recognition unit 6153 of the situation analysis unit 6133, the emergency situation avoidance unit 6171 of the operation control unit 6135, and the like.

The vehicle state detection unit 6143 performs detection processing for a state of the own vehicle based on data or a signal from each of the units of the vehicle control system 6100. The state of the own vehicle to be detected includes speed, acceleration, a steering angle, presence or absence and content of an abnormality, a state of driving operation, a position and inclination of a power seat, a state of door lock, and a state of another in-vehicle device, for example. The vehicle state detection unit 6143 supplies data indicating a result of the detection processing to the situation recognition unit 6153 of the situation analysis unit 6133, the emergency situation avoidance unit 6171 of the operation control unit 6135, and the like.

The self-position estimation unit 6132 performs estimation processing for a position, a posture, and the like of the own vehicle based on data or a signal from each of the units of the vehicle control system 6100 such as the vehicle exterior information detection unit 6141 and the situation recognition unit 6153 of the situation analysis unit 6133. Also, the self-position estimation unit 6132 generates a local map (hereinbelow referred to as a self-position estimation map) for use in estimation of a self-position as needed. The self-position estimation map is a highly accurate map using a technique such as simultaneous localization and mapping (SLAM), for example. The self-position estimation unit 6132 supplies data indicating a result of the estimation processing to the map analysis unit 6151, the traffic rule recognition unit 6152, and the situation recognition unit 6153 of the situation analysis unit 6133, and the like. Also, the self-position estimation unit 6132 stores the self-position estimation map in the storage unit 6111.

The situation analysis unit 6133 performs analysis processing for a situation of the own vehicle and the surroundings. The situation analysis unit 6133 includes the map analysis unit 6151, the traffic rule recognition unit 6152, the situation recognition unit 6153, and a situation prediction unit 6154.

The map analysis unit 6151 performs analysis processing for various maps stored in the storage unit 6111 with use of data or a signal from each of the units of the vehicle control system 6100 such as the self-position estimation unit 6132 and the vehicle exterior information detection unit 6141 as needed to build a map containing information required for autonomous driving processing. The map analysis unit 6151 supplies the built map to the traffic rule recognition unit 6152, the situation recognition unit 6153, and the situation prediction unit 6154, and a route planning unit 6161, an action planning unit 6162, and an operation planning unit 6163 of the planning unit 6134, and the like.

The traffic rule recognition unit 6152 performs recognition processing for a traffic rule around the own vehicle based on data or a signal from each of the units of the vehicle control system 6100 such as the self-position estimation unit 6132, the vehicle exterior information detection unit 6141, and the map analysis unit 6151. By this recognition processing, a position and a state of a traffic light around the own vehicle, content of a traffic regulation around the own vehicle, and a lane in which the vehicle can travel, and the like are recognized. The traffic rule recognition unit 6152 supplies data indicating a result of the recognition processing to the situation prediction unit 6154 and the like.

The situation recognition unit 6153 performs recognition processing for a situation related to the own vehicle based on data or a signal from each of the units of the vehicle control system 6100 such as the self-position estimation unit 6132, the vehicle exterior information detection unit 6141, the vehicle interior information detection unit 6142, the vehicle state detection unit 6143, and the map analysis unit 6151. For example, the situation recognition unit 6153 performs recognition processing for a situation of the own vehicle, a situation around the own vehicle, a situation of the driver of the own vehicle, and the like. Also, the situation recognition unit 6153 generates a local map (hereinbelow referred to as a situation recognition map) for use in recognition of the situation around the own vehicle as needed. The situation recognition map is an Occupancy Grid Map, for example.

The situation of the own vehicle to be recognized includes a position, a posture, and movement (for example, speed, acceleration, and a moving direction) of the own vehicle, and presence or absence and content of an abnormality, for example. The situation around the own vehicle to be recognized includes a kind and a position of a surrounding stationary object, a kind, a position, and movement (for example, speed, acceleration, and a moving direction) of a surrounding moving object, a configuration and a surface state of a surrounding road, and surrounding weather, temperature, humidity, and brightness, for example. The state of the driver to be recognized includes a physical condition, a wakefulness level, a concentration level, a fatigue level, movement of a line-of-sight, and driving operation, for example.

The situation recognition unit 6153 supplies data indicating a result of the recognition processing (including the situation recognition map, as needed) to the self-position estimation unit 6132, the situation prediction unit 6154, and the like. Also, the situation recognition unit 6153 stores the situation recognition map in the storage unit 6111.

The situation prediction unit 6154 performs prediction processing for a situation related to the own vehicle based on data or a signal from each of the units of the vehicle control system 6100 such as the map analysis unit 6151, the traffic rule recognition unit 6152, and the situation recognition unit 6153. For example, the situation prediction unit 6154 performs prediction processing for a situation of the own vehicle, a situation around the own vehicle, a situation of the driver, and the like.

The situation of the own vehicle to be predicted includes movement of the own vehicle, occurrence of an abnormality, and a travelable distance, for example. The situation around the own vehicle to be predicted includes movement of a moving body around the own vehicle, a change in state of a traffic light, and a change in environment such as weather, for example. The situation of the driver to be predicted includes behavior and a physical condition of the driver, for example.

The situation prediction unit 6154 supplies data indicating a result of the prediction processing as well as data from the traffic rule recognition unit 6152 and the situation recognition unit 6153 to the route planning unit 6161, the action planning unit 6162, and the operation planning unit 6163 of the planning unit 6134, and the like.

The route planning unit 6161 plans a route to a destination based on data or a signal from each of the units of the vehicle control system 6100 such as the map analysis unit 6151 and the situation prediction unit 6154. For example, the route planning unit 6161 sets a route from a current position to a specified destination based on the global map. Also, for example, the route planning unit 6161 changes the route as appropriate based on a situation of traffic congestion, an accident, traffic regulation, construction, and the like, and a physical condition and the like of the driver. The route planning unit 6161 supplies data indicating the planned route to the action planning unit 6162 and the like.

The action planning unit 6162 plans an action of the own vehicle for safe traveling through the route planned by the route planning unit 6161 within a planned period of time based on data or a signal from each of the units of the vehicle control system 6100 such as the map analysis unit 6151 and the situation prediction unit 6154. For example, the action planning unit 6162 makes plans for starting, stopping, a traveling direction (for example, a forward movement, a backward movement, a left turn, a right turn, and a change in direction), a traveling lane, traveling speed, and overtaking. The action planning unit 6162 supplies data indicating the planned action of the own vehicle to the operation planning unit 6163 and the like.

The operation planning unit 6163 plans operation of the own vehicle to achieve the action planned by the action planning unit 6162 based on data or a signal from each of the units of the vehicle control system 6100 such as the map analysis unit 6151 and the situation prediction unit 6154. For example, the operation planning unit 6163 makes plans for acceleration, deceleration, and a traveling course. The operation planning unit 6163 supplies data indicating the planned operation of the own vehicle to an acceleration/deceleration control unit 6172 and a direction control unit 6173 of the operation control unit 6135, and the like.

The operation control unit 6135 controls operation of the own vehicle. The operation control unit 6135 includes the emergency situation avoidance unit 6171, the acceleration/deceleration control unit 6172, and the direction control unit 6173.

The emergency situation avoidance unit 6171 performs detection processing for an emergency situation such as collision, contact, entry into a danger zone, an abnormality of the driver, and an abnormality of the vehicle based on the detection result from the vehicle exterior information detection unit 6141, the vehicle interior information detection unit 6142, and the vehicle state detection unit 6143. In a case of detecting occurrence of an emergency situation, the emergency situation avoidance unit 6171 plans operation of the own vehicle, such as a sudden stop or a sharp turn, to avoid the emergency situation. The emergency situation avoidance unit 6171 supplies data indicating the planned operation of the own vehicle to the acceleration/deceleration control unit 6172, the direction control unit 6173, and the like.

The acceleration/deceleration control unit 6172 performs acceleration/deceleration control for achieving the operation of the own vehicle planned by the operation planning unit 6163 or the emergency situation avoidance unit 6171. For example, the acceleration/deceleration control unit 6172 calculates a control target value for the driving force generation device or the braking device for achieving planned acceleration, deceleration, or sudden stop and supplies a control command indicating the calculated control target value to the drive-line control unit 6107.

The direction control unit 6173 performs direction control for achieving the operation of the own vehicle planned by the operation planning unit 6163 or the emergency situation avoidance unit 6171. For example, the direction control unit 6173 calculates a control target value for the steering mechanism for achieving the traveling course or the sharp turn planned by the operation planning unit 6163 or the emergency situation avoidance unit 6171 and supplies a control command indicating the calculated control target value to the drive-line control unit 6107.

The information processing device 10d according to the fourth embodiment described above is connected to the communication unit 6103, for example. In other words, the information processing device 10d can be regarded as a terminal device that communicates with the autonomous driving control unit 6112 and the like via the communication unit 6103.

The outputs of the processing units 30a, 30b, and 30c and the control state information output from the control unit 40d in the information processing device 10d are output from the information processing device 10d and are supplied to the autonomous driving control unit 6112 via the communication unit 6103. The autonomous driving control unit 6112 appropriately processes, in each of the units included therein, the outputs from the respective processing units 30a, 30b, and 30c based on the control state information output from the information processing device 10d.

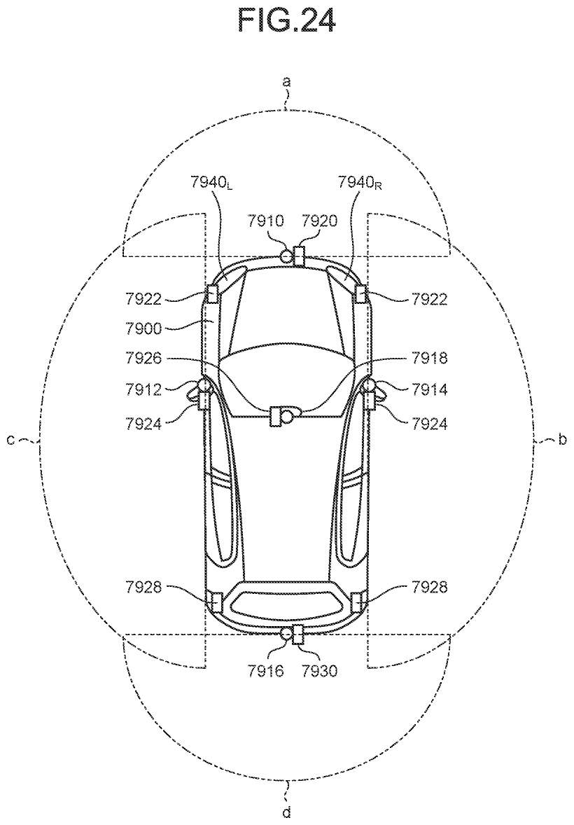

FIG. 24 illustrates an example of installation positions of the image capturing device included in the data acquisition unit 6102. Image capturing units 7910, 7912, 7914, 7916, and 7918 to which the image capturing device can be applied are provided at at least one position out of the front nose, side mirrors, rear bumper, back door, and upper part of the windshield in the vehicle interior of a vehicle 7900, for example. The image capturing unit 7910 provided at the front nose and the image capturing unit 7918 provided at the upper part of the windshield in the vehicle interior mainly acquire images of a front side of the vehicle 7900. The image capturing units 7912 and 7914 provided at the side mirrors mainly acquire images of lateral sides of the vehicle 7900. The image capturing unit 7916 provided at the rear bumper or the back door mainly acquires an image of a rear side of the vehicle 7900. The image capturing unit 7918 provided at the upper part of the windshield in the vehicle interior is mainly used for detecting a lead vehicle, a pedestrian, an obstacle, a traffic light, a traffic sign, a lane, or the like.

Note that FIG. 24 illustrates examples of image capturing ranges for the respective image capturing units 7910, 7912, 7914, and 7916. An image capturing range a indicates an image capturing range for the image capturing unit 7910 provided at the front nose, image capturing ranges b and c indicate image capturing ranges for the image capturing units 7912 and 7914 provided at the side mirrors, respectively, and an image capturing range d indicates an image capturing range for the image capturing unit 7916 provided at the rear bumper or back door. For example, by superimposing image data captured by the image capturing units 7910, 7912, 7914, and 7916, a bird's-eye view image of the vehicle 7900 as viewed from above can be obtained.

Vehicle exterior information detection units 7920, 7922, 7924, 7926, 7928, and 7930 provided at the front, rear, sides, and corners and at the upper part of the windshield in the vehicle interior in the vehicle 7900 may be ultrasonic sensors or radar devices, for example. The vehicle exterior information detection units 7920, 7926, and 7930 provided at the front nose, rear bumper, back door, and upper part of the windshield in the vehicle interior of the vehicle 7900 may be LiDAR devices, for example. These vehicle exterior information detection units 7920 to 7930 are mainly used for detecting a lead vehicle, a pedestrian, an obstacle, or the like.

Also, in FIG. 24, headlight boxes 7940_{L} and 7940_{R} are provided at the right and left ends of the front of the vehicle 7900. A headlight housed in the headlight box 7940_{L} can be used as the light source 21^{L} described above. Also, the image sensor 20_{L} is housed in the headlight box 7940_{L} with the optical axes of the image sensor 20_{L} and the light source 21_{L} (headlight) substantially aligned with each other. Also, the image sensor 20_{C} can be provided at the position of the image capturing unit 7910. The image capturing unit 7910 may be used as the image sensor 20_{C}.

Note that the present technique can also employ the following configuration.
(1) An information processing device comprising:

a control unit that controls driving of a light source in accordance with control information; and

a processing unit that acquires state information indicating a state of a subject surface based on an image adaptive to light irradiated on the subject surface from the light source detected by an image sensor and the control information.
(2) The information processing device according to (1),

wherein the control unit

modulates light emitted from the light source in accordance with the control information, and

the processing unit

performs synchronous detection based on the control information on the image detected by the image sensor and acquires the state information.
(3) The information processing device according to (2),

wherein the control unit

performs the modulation in accordance with the control information adaptive to unique information unique to the information processing device.
(4) The information processing device according to (3),

wherein the control unit performs the modulation by changing the control information over time in accordance with a rule adaptive to the unique information.
(5) The information processing device according to (1),

wherein the processing unit

acquires the state information with use of the image detected by the image sensor whose optical axis is substantially aligned with an optical axis of the light source.
(6) The information processing device according to (5),

wherein the control unit

controls driving of the light source in accordance with the control information for controlling an on state and an off state of the light source, and

the processing unit

acquires, based on the control information, the state information with use of a first image detected by the image sensor in the on state and a second image detected by the image sensor in the off state.
(7) The information processing device according to (6),

wherein the processing unit

acquires the state information based on a difference between average luminance of respective pixels included in the first image and average luminance of respective pixels included in the second image.
(8) The information processing device according to (1),

wherein the control unit

drives the light source using a pattern serving as an image as the control information.
(9) The information processing device according to (8),

wherein the processing unit

acquires the state information with use of an image with the pattern detected by the image sensor a direction of the optical axis of which and a direction of the optical axis of the light source form an angle having a predetermined value or higher.
(10) The information processing device according to (9),

wherein the processing unit

acquires the state information with use of the two or more images with the pattern detected by the two or more image sensors the angles of which differ from each other.
(11) The information processing device according to any one of (8) to (10),

wherein the processing unit

calculates as a virtual image an image obtained in a case in which it is assumed that the image sensor detects the pattern irradiated by the light source on a virtual subject surface obtained in a case in which it is assumed that the subject surface is completely flat, and acquires the state information based on a difference between the virtual image and the image with the pattern actually detected by the image sensor.
(12) The information processing device according to any one of (8) to (11),

wherein the control unit

changes a size of the pattern over time.
(13) The information processing device according to any one of (8) to (12),

wherein the processing unit

detects inclination of the subject surface based on distortion of the pattern in a vertical direction in the image with the pattern detected by the image sensor.
(14) The information processing device according to any one of (8) to (13),

wherein the pattern is a grid pattern.
(15) The information processing device according to (1),

wherein the control unit

executes sequentially in a repetitive manner

processing in which the control unit modulates light emitted from the light source in accordance with the control information, and in which the processing unit performs synchronous detection based on the control information on the image detected by the image sensor and acquires the state information,

processing in which the processing unit acquires the state information with use of the image detected by the image sensor whose optical axis is substantially aligned with the optical axis of the light source, and

processing in which the control unit drives the light source using the pattern serving as an image as the control information.
(16)

The information processing device according to any one of (1) to (15),

in which the subject surface is a road surface.
(17) A terminal device comprising:

a control unit that controls driving of a light source in accordance with control information;

a processing unit that acquires state information indicating a state of a subject surface based on an image adaptive to light irradiated on the subject surface from the light source detected by an image sensor and the control information; and

a transmission unit that transmits the state information that the processing unit acquires to a movable body on which an own device is mounted.
(18) The terminal device according to (17),

wherein the light source is a headlight that irradiates light to a front side of the movable body.
(19) The terminal device according to (17) or (18),

wherein the subject surface is a road surface on which the movable body travels.
(20) An information processing method comprising:

a control step of controlling driving of a light source in accordance with control information; and

a processing step of acquiring state information indicating a state of a subject surface based on an image adaptive to light irradiated on the subject surface from the light source detected by an image sensor and the control information.
(21) An information processing program causing a computer to execute:

a control step of controlling driving of a light source in accordance with control information; and

a processing step of acquiring state information indicating a state of a subject surface based on an image adaptive to light irradiated on the subject surface from the light source detected by an image sensor and the control information.

### REFERENCE SIGNS LIST

2, 24, 7900 VEHICLE

10, 10a, 10b, 10c, 10d INFORMATION PROCESSING DEVICE

20, 20_{C}, 20_{L}, 20_{R} IMAGE SENSOR

21, 21_{L}, 21_{R} LIGHT SOURCE

30, 30a, 30b, 30c PROCESSING UNIT

40, 40a, 40b, 40c, 40d CONTROL UNIT

100 OSCILLATOR

101 MULTIPLIER

102 LPF

300 AVERAGE VALUE CALCULATION UNIT

302, 500, 501, 504, 505 SWITCH UNIT

303a, 303b AVERAGE VALUE STORAGE UNIT

304 SUBTRACTOR

305 DETERMINATION UNIT

310 IMAGE STORAGE UNIT

311 CALCULATION UNIT

312 COMPUTATION UNIT

410, 410′ IMAGE PATTERN

1. An information processing device comprising:
a control unit that controls driving of a light source in accordance with control information; and
a processing unit that acquires state information indicating a state of a subject surface based on an image adaptive to light irradiated on the subject surface from the light source detected by an image sensor and the control information.

2. The information processing device according to claim 1,
wherein the control unit
modulates light emitted from the light source in accordance with the control information, and
the processing unit
performs synchronous detection based on the control information on the image detected by the image sensor and acquires the state information.

3. The information processing device according to claim 2,
wherein the control unit
performs the modulation in accordance with the control information adaptive to unique information unique to the information processing device.

4. The information processing device according to claim 3,
wherein the control unit performs the modulation by changing the control information over time in accordance with a rule adaptive to the unique information.

5. The information processing device according to claim 1,
wherein the processing unit
acquires the state information with use of the image detected by the image sensor whose optical axis is substantially aligned with an optical axis of the light source.

6. The information processing device according to claim 5,
wherein the control unit
controls driving of the light source in accordance with the control information for controlling an on state and an off state of the light source, and
the processing unit
acquires, based on the control information, the state information with use of a first image detected by the image sensor in the on state and a second image detected by the image sensor in the off state.

7. The information processing device according to claim 6,
wherein the processing unit
acquires the state information based on a difference between average luminance of respective pixels included in the first image and average luminance of respective pixels included in the second image.

8. The information processing device according to claim 1,
wherein the control unit
drives the light source using a pattern serving as an image as the control information.

9. The information processing device according to claim 8,
wherein the processing unit
acquires the state information with use of an image with the pattern detected by the image sensor a direction of the optical axis of which and a direction of the optical axis of the light source form an angle having a predetermined value or higher.

10. The information processing device according to claim 9,
wherein the processing unit
acquires the state information with use of the two or more images with the pattern detected by the two or more image sensors the angles of which differ from each other.

11. The information processing device according to claim 8,
wherein the processing unit
calculates as a virtual image an image obtained in a case in which it is assumed that the image sensor detects the pattern irradiated by the light source on a virtual subject surface obtained in a case in which it is assumed that the subject surface is completely flat, and acquires the state information based on a difference between the virtual image and the image with the pattern actually detected by the image sensor.

12. The information processing device according to claim 8,
wherein the control unit
changes a size of the pattern over time.

13. The information processing device according to claim 8,
wherein the processing unit
detects inclination of the subject surface based on distortion of the pattern in a vertical direction in the image with the pattern detected by the image sensor.

14. The information processing device according to claim 8,
wherein the pattern is a grid pattern.

15. The information processing device according to claim 1,
wherein the control unit
executes sequentially in a repetitive manner
processing in which the control unit modulates light emitted from the light source in accordance with the control information, and in which the processing unit performs synchronous detection based on the control information on the image detected by the image sensor and acquires the state information,
processing in which the processing unit acquires the state information with use of the image detected by the image sensor whose optical axis is substantially aligned with the optical axis of the light source, and
processing in which the control unit drives the light source using the pattern serving as an image as the control information.

16. A terminal device comprising:
a control unit that controls driving of a light source in accordance with control information;
a processing unit that acquires state information indicating a state of a subject surface based on an image adaptive to light irradiated on the subject surface from the light source detected by an image sensor and the control information; and
a transmission unit that transmits the state information that the processing unit acquires to a movable body on which an own device is mounted.

17. The terminal device according to claim 16,
wherein the light source is a headlight that irradiates light to a front side of the movable body.

18. The terminal device according to claim 16,
wherein the subject surface is a road surface on which the movable body travels.

19. An information processing method comprising:
a control step of controlling driving of a light source in accordance with control information; and
a processing step of acquiring state information indicating a state of a subject surface based on an image adaptive to light irradiated on the subject surface from the light source detected by an image sensor and the control information.

20. An information processing program causing a computer to execute:
a control step of controlling driving of a light source in accordance with control information; and
a processing step of acquiring state information indicating a state of a subject surface based on an image adaptive to light irradiated on the subject surface from the light source detected by an image sensor and the control information.
